(19) United States
(12) Patent Application Publication
(10) Pub. No.: US 2008/0230531 A1
(43) Pub. Date: Sep. 25, 2008

(54) HEAT BLOCK

(76) Inventors: CHIH-MING CHOU, Kaohsiung City (TW); Yu-Jen Wang, Kaohsiung City (TW); Chao-Yung Wang, Kaohsiung City (TW); Yu-Ping Lin, Kaohsiung City (TW); Chen-Ping Su, Kaohsiung City (TW)

Correspondence Address: PATTERSON & SHERIDAN, L.L.P., 3040 POST OAK BOULEVARD, SUITE 1500, HOUSTON, TX, 77056, US

(21) Appl. No.: 11/845,626

(22) Filed: Aug. 27, 2007

(30) Foreign Application Priority Data
Mar. 20, 2007 (TW) 96109602

(51) Int. Cl. H05B 3/20

(52) U.S. Cl. 219/228

(57) ABSTRACT

A heat block for holding an electronic device is disclosed. The heat block comprises a base and at least one discharge device. The discharge device is disposed on the base. The discharge device is electrically conductive and is grounded. When the electronic device is placed on the base, the discharge device is in contact with an electrical contact of the electronic device.

### RELATED APPLICATIONS

This application claims priority to Taiwan Application Serial Number 96109602, filed Mar. 20, 2007, which is herein incorporated by reference.

### BACKGROUND OF THE INVENTION

1. Field of the Invention

This invention relates to a heat block, and more particularly, to a heat block that discharges electricity when holding an electronic device.

2. Description of the Related Art

In the semiconductor package process, the chip is disposed on a holder, such as a lead frame or a flexible circuit board. Then, a wire bonding process is performed, and a conducting wire (gold wire) is respectively connected to the chip and the holder, thereby electrically connecting the chip and the holder.

When the wire bonding process is performed, the holder bonding with the chip is first placed on a heat block of the wire bonding equipment, and then a hold down clamp holds the chip to stabilize the chip on the heat block for wire bonding. Meanwhile, the heat block rapidly conducts heat to the finger of the holder and the bond pad of the chip, so as to make the conducting wires easier to bond with the finger of the holder and the bond pad of the chip.

However, the holder may have the electric capacity which is charged, and the passive device may discharge electricity to the chip in the wire bonding process. Therefore, the chip can be burned out by the discharge, and could be unusable.

### SUMMARY OF THE INVENTION

Therefore, an aspect of the present invention is to provide a heat block to discharge electricity when holding an electronic device, thereby preventing the electronic device from being burned out by unexpected current or charge.

Another aspect of the present invention is to provide a heat block with at least one discharge device disposed in at least one receiving hole to touch an electronic device disposed above but not to be blocked by the rough and uneven surface of the electronic device, thereby discharging electricity.

According to an embodiment of the present invention, the heat block comprises a base, at least one receiving hole and at least one discharge device. The receiving hole is formed on the base. The discharge device disposed in the receiving hole, wherein the discharge device is electrically conductive and grounded, and when the electronic device is placed on the base, the discharge device is in contact with an electrical contact of the electronic device.

According to another embodiment of the present invention, the discharge device is an electrically conductive plastic film for discharging electricity.

Therefore, with the application of the heat block disclosed in the embodiments of the present invention, the heat block discharges electricity when holding the electronic device, so as to prevent the electronic device form being burned out by unexpected current or charge. Further, when the discharge device of the heat block is in contact with the electronic device, the discharge device can prevent the electronic device from damage, such as scrape damage.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a cross-sectional view showing a heat block according to a first embodiment of the present invention;

FIG. 2 is a three dimensional view of a heat block according to a first embodiment of the present invention;

FIG. 3 is an exploded view showing a heat block in guiding according to a second embodiment of the present invention;

FIG. 4 is a front view showing a heat block according to a second embodiment of the present invention;

FIG. 5 is a front view showing a heat block according to a third embodiment of the present invention;

FIG. 6 is a cross-sectional view showing a heat block according to a fourth embodiment of the present invention; and

FIG. 7 is a three dimensional view showing a heat block according to a fifth embodiment of the present invention.

### DETAILED DESCRIPTION OF THE PREFERRED EMBODIMENT

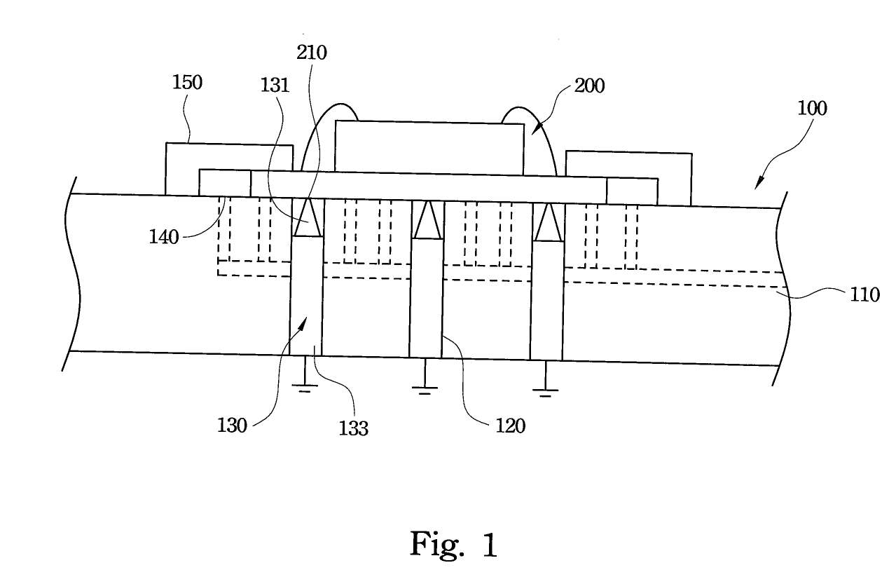

In order to make the illustration of the present invention more explicit and complete, the following description is stated with reference to FIG. 1 through FIG. 7.

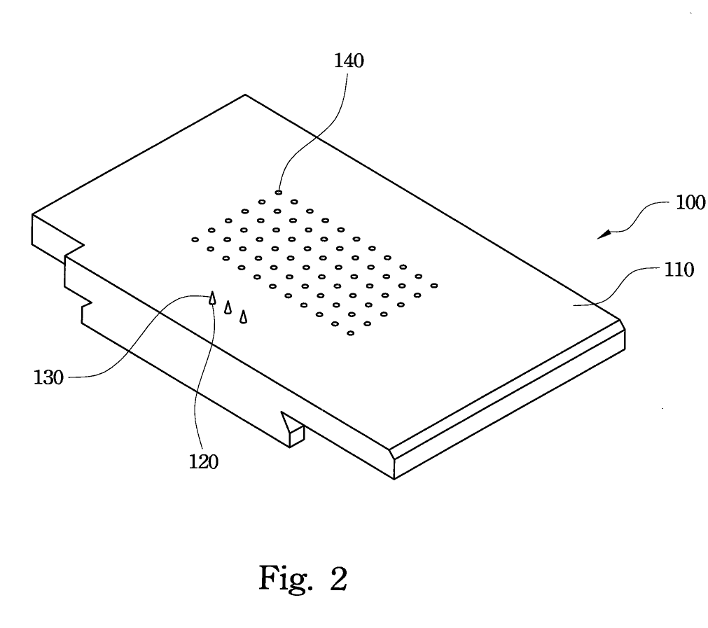

Refer to FIG. 1 and FIG. 2. FIG. 1 is a cross-sectional view showing a heat block according to a first embodiment of the present invention, and FIG. 2 is a three dimensional view of a heat block according to a first embodiment of the present invention. The heat block 100 of the first embodiment is disposed on a wire bonding equipment to hold an electronic device (not shown). The electronic device 200 may be a holder bonding with a chip and/or a passive device, and the holder may be a lead frame, a substrate, a printed circuit board or a flexible circuit board. However, the electronic device 200 may be other electronic devices but not limited to the above description. The heat block 100 comprises a base 110, at least one receiving hole 120, at least one discharge device 130 and at least one vacuum attracting hole 140. The receiving hole 120 is disposed on the base 110 to receive the discharge device 130. The discharge device 130 is electrically conductive and grounded. When the electronic device 130 is placed on the base 110 for wire bonding, the discharge device 130 is in contact with an electrical contact 210 of the electronic device 200, thereby releasing electric charge or current to ground and preventing the electronic device 200 form being burned thereby. The vacuum hole 140 is disposed on the base 110 to secure the electronic device 200 on the base. A hold down clamp 150 is pressed on the electronic device 200 on the base 110 to further hold the electronic device 200 on the base 110.

Refer to FIG. 1 and FIG. 2 again. The base 110 of the first embodiment is made of thermally conductive material, such as metallic material or ceramic material, thereby rapidly conducting heat to the electronic device 200. The receiving hole 120 of the first embodiment may be at least one through hole disposed on the base 110 to receive the discharge device 130. The position of the receiving hole 120 corresponds to the electrical contact 210 of the electronic device 200, whereby the discharge device 130 disposed in the receiving hole 120 can touch the electrical contact 210 thereof and discharge electricity from the electronic device 200.

It is worth mentioning that the position of the receiving hole 120 and the discharge device 130 is predetermined by the position of the electrical contact 210 of the electronic device 200, whereby the discharge device 130 can touch the electrical contact 210 thereof. For example, when the electronic device 200 is a holder bonding with a chip, the electrical contact 210 may be a bond pad of the printed circuit board, a gold finger of substrate or a lead of the lead frame. However, the present invention does not limit the electrical contact 210 to the above description. The electrical contact 210 of the electronic device 200 may be a contact which the discharge device 130 can be in contact with, so as to discharge electricity through the discharge device 130 to ground. Therefore, the electrical contact 210 of the electronic device 200 may be any electrically conductive portion or surface of the electronic device 200.

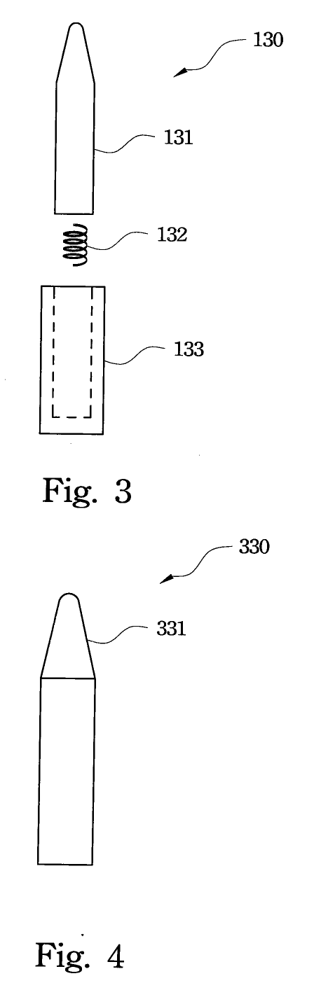

Refer to FIG. 3. FIG. 3 is an exploded view showing a heat block according to a first embodiment of the present invention. The discharge device 130 of the first embodiment is disposed in the receiving hole 120, and is grounded through the base 110 or the wire bonding equipment. The discharge device 130 has a discharge probe 131, an elastic element 132 and a socket 133. The discharge probe 131 and the elastic element 132 are disposed in the socket 133. The elastic element 132 may be a spring disposed below the discharge probe 131, thereby allowing the discharge probe 131 to be movable in the receiving hole 120 corresponding to the electrical contact 210 of the electronic device 200 when the electronic device 200 is placed on the base. Therefore, the elastic element 132 is disposed between the discharge probe 131 and the socket 133 to bias the discharge probe 131 upwards and against the electrical contact 210 of the electronic device 200. The socket 133 is tightly mounted in the receiving hole 120. The discharge probe 131, the elastic element 132 and the socket 133 are made of electrically conductive material, such as metallic material, and are electrically conductive. Therefore, when the electronic device 200 is placed on the base 110, the discharge probe 131 of the discharge device 130 upward touches the electrical contact 210 thereof to discharge electricity.

It is worth mentioning that most of the electronic device 200 has a rough and uneven surface, and the elastic element 132 elastically biases the discharge probe 131 against the electrical contact 210 of the electronic device 200. Therefore, the discharge device 130 can touch the upper electrical contact 210 of the electronic device 200 without being blocked by the rough and uneven surface thereof. Moreover, the discharge device 130 can elastically perform vertical movements, thereby preventing the electronic device 200 form damage (like scrape damage) caused by the discharge device 130.

Refer to FIG. 1 and FIG. 2 again. The vacuum hole 140 of the first embodiment is connected to a vacuum pump to extract air. Therefore, when wire bonding, the electronic device 200 is placed on the base 110, and can be attracted thereon by the vacuum hole 140. Further, the hold down clamp 150 holds the electronic device 200 on the base, so as to stably hold the electronic device 200 on the base 110. Meanwhile, the electronic device 200 is discharged by the discharge device 130 of the first embodiment, thereby preventing the electronic device 200 from being burned out by unexpected current, charged electric capacity or static electric charge when performing the wire bonding process.

Refer to FIG. 4. FIG. 4 is a front view showing a heat block according to a second embodiment of the present invention. Same reference numerals shown in FIG. 1 are used in the second embodiment of the present invention. The construction of the heat block structure shown in the second embodiment is similar to that in the first embodiment with respect to configuration and function, and thus is not stated in detail herein.

Refer again to FIG. 4. In comparison with the first embodiment, the discharge device 330 of the second embodiment is disposed in the receiving hole 120 and has a tip portion 331 formed on the tip of the discharge device 330 to touch the electrical contact 210 of the electronic device 200, wherein the tip portion 331 is made of flexible and electrically conductive material, such as electrically conductive plastic material. Therefore, when the tip portion 331 of the discharge device 330 is in contact with the electrical contact 210 thereof, the tip portion 331 deforms corresponding to the electrical contact 210 thereof, and the elastic element 132 can be replaceable in the second embodiment.

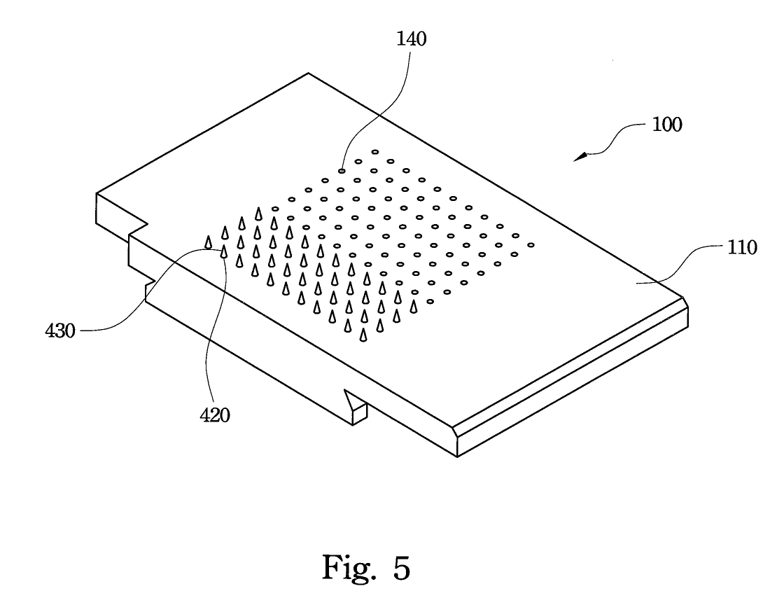

Refer to FIG. 5. FIG. 5 is a front view showing a heat block according to a third embodiment of the present invention. Same reference numerals shown in FIG. 1 are used in the third embodiment of the present invention. The construction of the heat block structure shown in the third embodiment is similar to that in the first embodiment with respect to configuration and function, and thus is not stated in detail herein.

Refer again to FIG. 5. In comparison with the first embodiment, the heat block 100 of the third embodiment has a plurality of receiving holes 420 and a plurality of discharge devices 430 which are disposed and partially or entirely distributed on the base 110. It is worth mentioning that the receiving holes 420 and the discharge devices 430 of the third embodiment are not necessary to position to the electrical contact 210 of the electronic device 200. Therefore, when the electronic device 200 is placed on the base 110, the discharge devices 430 touches the electrical contact 210 thereof to discharge electricity. Namely, the discharge devices 430 distributed on the base 10 can prevent the electrical contact 210 of the electronic device 200 from being not positioned to the discharge devices 430, and therefore can ensure that the electricity in the electronic device 200 can be discharged thereby.

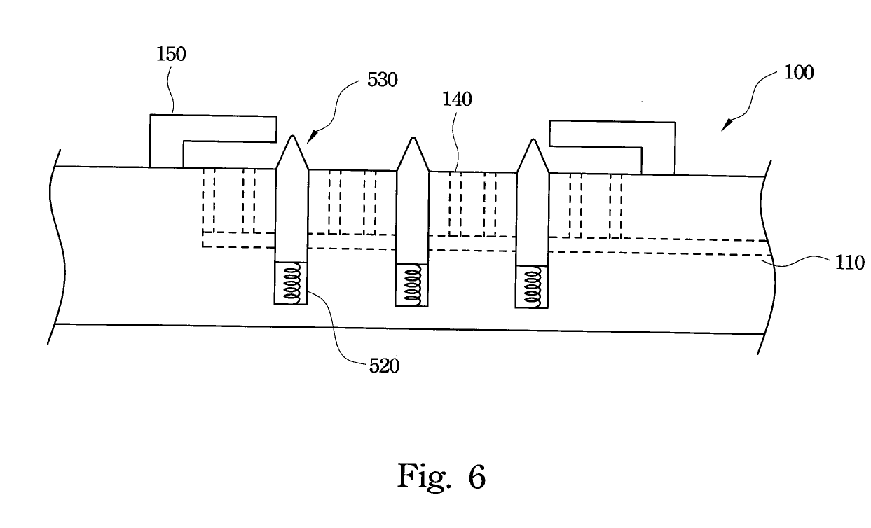

Refer to FIG. 6. FIG. 6 is a cross-sectional view showing a heat block according to a fourth embodiment of the present invention. Same reference numerals shown in FIG. 1 are used in the fourth embodiment of the present invention. The construction of the heat block structure shown in the fourth embodiment is similar to that in the first embodiment with respect to configuration and function, and thus is not stated in detail herein.

Refer again to FIG. 6. In comparison with the first embodiment, the receiving hole 520 of the fourth embodiment is at least one blind hole. Therefore, the discharge device 530 is disposed straight into the blind hole, and the socket 133 of the first embodiment can be omitted in the fourth embodiment, whereby the amount of component of the discharge device 530 can be reduced.

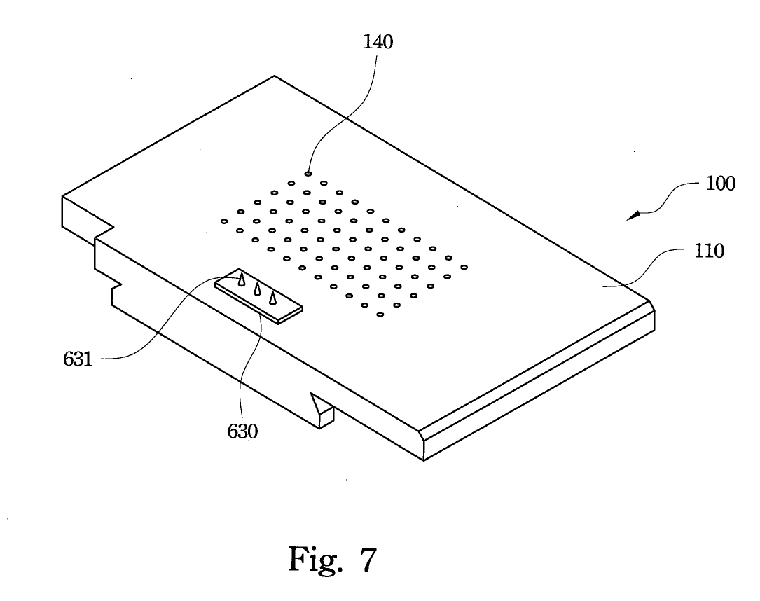

Refer to FIG. 7. FIG. 7 is a three dimensional view showing a heat block according to a fifth embodiment of the present invention. Same reference numerals shown in FIG. 1 are used in the fifth embodiment of the present invention. The construction of the heat block structure shown in the fifth embodiment is similar to that in the first embodiment with respect to configuration and function, and thus is not stated in detail herein.

Refer again to FIG. 7. In comparison with the first embodiment, the discharge device 630 of the fifth embodiment is an electrically conductive plastic film disposed and grounded on the base 110, and the receiving hole 120 of the first embodiment is omitted in the fifth embodiment. The discharge device 630 has a plurality of protruding structures 631 to touch the electrical contact 210 of the electronic device 200, so as to discharge electricity. Because the discharge device 630 of the fifth embodiment is flexible, the protruding structure 631 of the discharge device 630 deforms when touching the electrical contact 210 thereof to prevent the electronic device 200 from damage.

Therefore, the heat block shown in the respective embodiments of the present invention discharges electricity when holding the electronic device, so as to prevent the electronic device form being burned out by unexpected current or charge. Further, the discharge device of the heat block can upward touch the electrical contact of the electronic device but not to be blocked by the rough and uneven surface thereof. Besides, the discharge device has the elastic element or the tip portion with flexibility. Therefore, when the discharge device is in contact with the electronic device, the discharge device can prevent the electronic device from damage.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A heat block for holding an electronic device, comprising:
a base;
at least one receiving hole formed on the base; and
at least one discharge device disposed in the receiving hole, wherein the discharge device is electrically conductive and grounded, and when the electronic device is placed on the base, the discharge device is in contact with an electrical contact of the electronic device.

2. The heat block as claimed in claim 1, wherein the discharge device comprises:
a discharge probe disposed in the receiving hole, wherein the discharge probe is electrically conductive; and
an elastic element disposed below the discharge probe for allowing the discharge probe to be movable corresponding to the electrical contact of the electronic device when the electronic device is placed on the base.

3. The heat block as claimed in claim 2, wherein the receiving hole is at least one blind hole.

4. The heat block as claimed in claim 1, wherein the discharge device comprises:
a socket disposed in the receiving hole;
a discharge probe disposed in the socket, wherein the discharge probe is electrically conductive; and
an elastic element disposed between the discharge probe and the socket for allowing the discharge probe to be movable corresponding to the electrical contact of the electronic device in the socket when the electronic device is placed on the base.

5. The heat block as claimed in claim 4, wherein the receiving hole is at least one through hole.

6. The heat block as claimed in claim 1, wherein the discharge device is disposed in the receiving hole, and the discharge device has a tip portion, and the tip portion is flexible and electrically conductive.

7. The heat block as claimed in claim 6, wherein the tip portion is made of electrically conductive plastic material.

8. The heat block as claimed in claim 1, wherein the base is mounted to a wire bonding equipment.

9. The heat block as claimed in claim 1, wherein the electronic device is a holder bonding with a chip.

10. The heat block as claimed in claim 9, wherein the holder is a circuit board flexible circuit board, or a substrate.

11. The heat block as claimed in claim 1, further comprising:
at least one vacuum hole disposed on the base and connected to a vacuum pump to attract the electronic device.

12. The heat block as claimed in claim 1, further comprising:
a hold down clamp for pressing the electronic device on the base.

13. The heat block as claimed in claim 1, wherein the base is made of high thermally conductive material.

14. A heat block for holding an electronic device, comprising:
a base; and
a discharge device disposed on the base, wherein the discharge devices is an electrically conductive plastic film and grounded, and when the electronic device is placed on the base, the discharge devices are in contact with an electrical contact of the electronic device.

15. The heat block as claimed in claim 14, wherein the electrically conductive plastic film has at least one protruding structure to touch the electrical contact of the electronic device.

16. A heat block for holding an electronic device, comprising:
a base; and
a plurality of receiving holes formed on base; and
a plurality of discharge devices disposed in the receiving holes, wherein the discharge devices are electrically conductive and grounded, and when the electronic device is placed on the base, the discharge devices are in contact with an electrical contact of the electronic device.

17. The heat block as claimed in claim 16, wherein each of the discharge devices comprises:
a discharge probe disposed in each of the receiving holes, wherein the discharge probe is electrically conductive; and
an elastic element disposed below the discharge probe for allowing the discharge probe to be movable corresponding to the electrical contact of the electronic device when the electronic device is placed on the base.

18. The heat block as claimed in claim 17, wherein each of the discharge devices further comprises:
a socket disposed in each of the receiving holes, wherein the elastic element and the discharge probe are received in the socket.
